(19) United States
(12) Patent Application Publication
(10) Pub. No.: US 2002/0052810 A1
(43) Pub. Date: May 2, 2002

(54) Method and apparatus for calculating an environmental indicator and recording medium with calculation program recorded thereon

(76) Inventor: Shigeyuki Kuroda, Hirakata-shi (JP)

Correspondence Address: RADER, FISHMAN & GRAUER, P.L.L.C, Suite 501, 1233 20th Street, NW, Washington, DC, 20036, US

(21) Appl. No.: 09/902,112

(22) Filed: Jul. 11, 2001

(30) Foreign Application Priority Data
Jul. 11, 2000 (JP) 2000-209620

(51) Int. Cl. G06F 17/60

(52) U.S. Cl. 705/29

(57) ABSTRACT

The discharged amount of efflux associated with environmental indicators for all the life cycle of a product is easily calculated. To this end, a memory stores (i) a part list data base having a collection of data on the part lists of products in conjunction with product identification codes, (ii) a product specification data base having a collection of data on the specifications of the products, (iii) a material code conversion table containing processing yields and environmental indicator factors in conjunction with material codes which respectively indicate the material of each part constituting a product, and (iv) a table for conversion by standardized parts. Based on a product identification code, a CPU extracts part numbers looking them up in the data bases; calculates a processing yield and environmental indicator factor for every material code by referring the data tables, the material codes relating to the parts corresponding to the part numbers which have been extracted; and calculates the discharged amount of efflux associated with an environmental indicator for every material code based on its corresponding processing yield and environmental indicator factor which have been obtained, while calculating the total amount of efflux discharged from the whole product.

### TECHNICAL FIELD

The present invention relates to an environmental indicator calculation technique and more particularly to a technique for calculating the environmental-indicator-related, discharged amount of efflux such as CO₂ generated throughout the entire life cycle of, for instance, a construction machine from its manufacture to its disposal.

### BACKGROUND ART

In recent years, while there is growing interest in global environmental problems such as greenhouse effect, acid rain, and ozone holes, the concept of the life cycle assessment (Environmental Life Cycle Assessment: LCA) is attracting attention. Taking the amount of CO₂ for example, this life cycle assessment is done based on the idea which takes account of not only factories or vehicles which generate CO₂ in a direct way, but also all the environmental loads presented by products throughout their life cycles (i.e., removal of natural resources, manufacture, use and recycling/disposal).

In such a situation, there exists a need for establishment of “environmental indicators” used for estimating the influence of a product upon the environment, and companies that manufacture various kinds of products are being required to evaluate their products with a new measure called the “environmental indicators”.

However, in the actual circumstances, there has not yet been sufficiently established how to set an environmental indicator nor any methods for calculating and evaluating it. In the case of a construction machine for instance, a machine is constituted by tens of thousands of parts and therefore if environmental indicators for such a large number of parts are calculated by hand, it must be extremely inefficient, involving much labor and time.

The present invention is directed to overcoming the above problem and a prime object of the invention is therefore to provide a method and apparatus for environmental indicator calculation capable of easily calculating, for example, the environmental-indicator-related, discharged amount of efflux of a construction machine throughout its entire life cycle, and to provide a computer-readable, recording medium for storing a program for the executing environmental indicator calculation by a computer.

### DISCLOSURE OF THE INVENTION

The above object can be accomplished by an environmental indicator calculation method according to a first aspect of the invention, the method comprising the steps of:

(1) storing a data base and a data table in a memory, the data base having a collection of data on the part lists and specifications of products in conjunction with product identification codes, the data table containing processing yields and environmental indicator factors in conjunction with material codes which respectively indicate the material of each part constituting a product;

(2) extracting part numbers by looking them up in the data base with a product identification code which has been input;

(3) calculating a processing yield and environmental indicator factor for every material code by referring the data table, the material codes relating to the parts corresponding to the part numbers which have been extracted; and

(4) calculating the discharged amount of efflux associated with an environmental indicator for every material code based on its corresponding processing yield and environmental indicator factor which have been obtained, while calculating the total amount of efflux discharged from the whole product.

According to the invention, a data base and a data table are stored in a memory. The data base has data associated with the part lists and product specifications of products in conjunction with product identification codes, whereas the data table has processing yields and environmental indicator factors in conjunction with material codes which respectively indicate the material of each part constituting a product. When a product identification code has been input, part numbers and product weights associated with the part numbers are extracted by looking them up in the data base with the product identification code. Then, a processing yield and environmental indicator factor for every material code are calculated by referring the data table, the material codes relating to the parts corresponding to the part numbers which have been extracted. Subsequently, the discharged amount of efflux associated with an environmental indicator for every material code is calculated based on its corresponding processing yield and environmental indicator factor which have been obtained, while calculating the total amount of efflux discharged from the whole product. In this way, the discharged amount of efflux (e.g., CO₂ discharged amount) associated with an environmental indicator can be easily calculated only by inputting a product identification code, so that data on the life cycle of a product can be obtained in a short time even if the product includes tens of thousands of parts. The data thus obtained can be utilized in evaluating the influence of the product system upon the environment. This method can be used not only for obtaining data on presently marketed models of a product for life cycle assessment, but also for obtaining data on newly developed models to be used as simulation data, by utilizing its CAD/CAM data.

There is provided an environmental indicator calculation apparatus according to a second aspect of the invention, the apparatus comprising:

(1) a data base having a collection of data on the part lists and specifications of products in conjunction with product identification codes;

(2) a data table containing processing yields and environmental indicator factors in conjunction with material codes which respectively indicate the material of each part constituting a product; and

(3) computing means for (i) extracting part numbers and the weight of a part associated with every part number by looking them up in the data base with a product identification code which has been input, (ii) calculating a processing yield and environmental indicator factor for every material code by referring the data table, the material codes relating to the parts corresponding to the part numbers which have been extracted, and (iii) calculating the discharged amount of efflux associated with an environmental indicator for every material code based on its corresponding processing yield and environmental indicator factor which have been obtained, while calculating the total amount of efflux discharged from the whole product.

The second aspect of the invention concretely implements the environmental indicator calculation method of the first aspect so that the second aspect achieves the same effect as that of the first aspect.

The discharged amount calculated by the computing means of the second aspect preferably includes: the discharged amount of efflux during preparation of the materials of the parts; the discharged amount of efflux during processing and assembling of the parts; the discharged amount of efflux during delivery and use of the product; and the discharged amount of efflux during disassembling and disposal of the product (a third aspect of the invention). With this arrangement, not only environmental data on the manufacture of a product, but also environmental data associated with the whole life of a product, that is, all the stages of manufacture, delivery to the customer, use, and disposal can be totally obtained and effectively utilized.

Preferably, the apparatus of the second and third aspects further include an abnormal code conversion table for converting a material code incorrectly given into a normal material code, and after conversion of an abnormal material code into a normal material code by referring this abnormal code conversion table, the aforesaid calculation of the processing yield and the environmental indicator factor is executed (a fourth aspect of the invention). With this arrangement, if material codes are input by different persons in different ways so that an abnormal material code is given, it can be converted into a normal material code to execute various arithmetic operations, so that an error can be prevented from occurring in totalization, arithmetic operations and others.

According to a fifth aspect of the invention, there is provided a computer-readable, recording medium for storing a program for executing an environmental indicator calculation process by a computer, the process comprising the steps of:

(1) extracting part numbers by looking them up in a data base with a product identification code which has been input, the data base having a collection of data on the part lists and specifications of products in conjunction with product identification codes;

(2) calculating a processing yield and environmental indicator factor for every material code by referring a data table, the material codes relating to the parts corresponding to the part numbers which have been extracted, the data table indicating processing yields and environmental indicator factors in conjunction with material codes which respectively indicate the material of each part constituting a product; and

(3) calculating the discharged amount of efflux associated with an environmental indicator for every material code based on its corresponding processing yield and environmental indicator factor which have been obtained, while calculating the total amount of efflux discharged from the whole product.

This recording medium is readable by a computer and stores a series of processing steps in the form of a program in order to implement the environmental indicator calculation method of the first aspect of the invention by a computer. Accordingly, calculation of environmental indicators can be more easily performed by letting a computer read this recording medium.

### BRIEF DESCRIPTION OF THE DRAWINGS

FIG. 1 is a hardware structure diagram of an environmental indicator computing system constructed according to one embodiment of the invention.

FIG. 2 is a flow chart showing a flow for calculating the amount of CO₂ discharged into the environment.

FIG. 3 shows a flow (1) of a CO₂ calculation procedure by way of a concrete data example.

FIG. 4 shows a flow (2) of the CO₂ calculation procedure by way of a concrete data example.

FIG. 5 shows a flow (3) of the CO₂ calculation procedure by way of a concrete data example.

FIG. 6 shows a flow (4) of the CO₂ calculation procedure by way of a concrete data example.

FIG. 7 shows a flow (5) of the CO₂ calculation procedure by way of a concrete data example.

### BEST MODE FOR CARRYING OUT THE INVENTION

Referring now to the accompanying drawings, there will be explained a method and apparatus for performing environmental indicator calculation and a recording medium according to a preferred embodiment of the invention.

In this embodiment, a construction machine (e.g., hydraulic shovels) is taken for an example of products and there will be explained the amounts of CO₂ discharged into the environments at the stages of (1) preparation of materials and (2) processing and assembling (for manufacturing a construction machine); and (3) delivery and use and (4) disassembling and disposal (after manufacture).

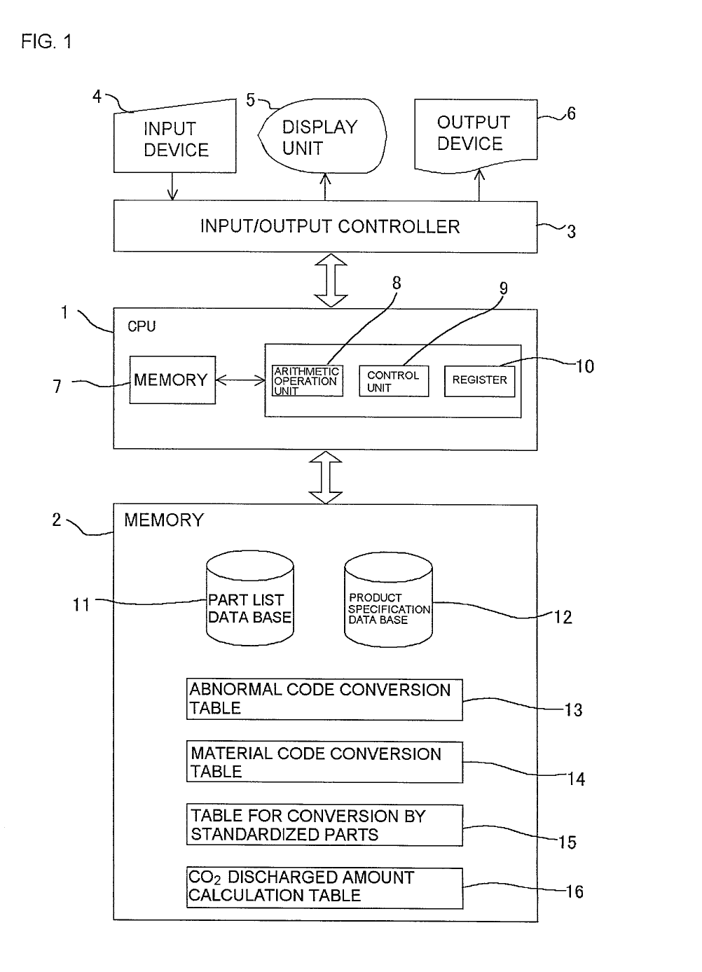

FIG. 1 shows a hardware structure diagram of an environmental indicator computing system constructed according to one embodiment of the invention.

The environmental indicator computing system of the present embodiment comprises a central processing unit (hereinafter referred to as “CPU”) 1 for uniformly controlling the entire system and a memory 2 connected to the CPU 1. Connected to the CPU 1 through an input/output controller 3 are (i) an input device 4 that is comprised of a pointing device such as a keyboard and mouse, (ii) a display unit 5 serving as a monitor for input data etc., and (iii) an output device 6 for outputting data such as the results of various totalizing operations.

The CPU 1 comprises (i) a memory 7 for storing various programs including a control program for an operating system etc. and desired data, (ii) an arithmetic operation unit (computing means) 8 for performing arithmetic operations and determinations, (iii) a control unit 9 for interpreting the program and performing overall control; and (iv) a register 10 for temporarily storing commands etc.

The memory 2 is a storage means such as a hard disk, flexible disk or optical disk. The memory 2 stores (i) a part list data base 11 in which part lists for products are arranged in conjunction with product identification codes such as the model names, type names, or unit article numbers of products, (ii) a product specification data base 12 in which data on the specifications of products are arranged in conjunction with the product identification codes; (iii) an abnormal code conversion table 13 for converting an incorrectly given material code into a normal material code; (iv) a material code conversion table 14 for converting a previous material code into a new material code; (v) a table for conversion by standardized parts 15 which table is used for converting a standardized part article number for in-house use into a material code for a standardized part; and (vi) a CO₂ discharged amount calculation table 16 for calculating the discharged amounts of CO₂ by models. In the material code conversion table 14 and the table for conversion by standardized parts 15, processing yields and environmental indicator factors (CO₂ factors in the present embodiment) are registered in conjunction with the material codes.

As described earlier, information necessary for calculation of the CO₂ discharged amount of a construction machine may be classified by the following four stages.

For the stages until manufacture of a product is finished, the following information is required:

(1) Information as to what kind of materials and how much material will be required for producing an object product (the material preparation stage).

(2) Information as to how much energy and sub-material will be required for forming parts from the materials and assembling the parts into a product (the processing and assembling stage).

For the stages from a delivery of the product to the customer until the lifetime of the product is ended after its operation, the following information is required:

(3) Information as to how much energy is necessary for delivering the product to the customer and how much energy and material will be consumed from a start of operation until the lifetime of the product is ended (the delivery and use stage).

(4) Information as to how much energy and material will be consumed from the time when the product ends its service life until it is scrapped, completing its life cycle (the disposal and disassembling stage).

Accordingly, the discharge mass (kg) of CO₂ at each stage needs to be calculated. First, a CO₂ discharge mass Y₁ at the material preparation stage is obtained from the following equation.

Y₁=Σ(Bi×Wi/Ai) (1)

Ai: processing yield by material

Bi: CO₂ discharging factor by material

Wi: the mass (kg) of parts by material

Regarding the CO₂ discharging factor by material Bi, the value which has been published by the public research group (National Institute for Resources and Environment (NIRE)) is used. The values of the processing yield by material Ai and the CO₂ discharging factor by material Bi are registered in the material code conversion table 14 and the table for conversion by standardized parts 15.

Although a CO₂ discharge mass Y₂ at the processing and assembling stage should be properly calculated by summing up the amounts of CO₂ discharged from materials consumed by the processes of material cutting, welding, casting, machine processing, thermal treatment, surface treatment, coating, delivery, assembling and maintenance, it is calculated, in the present embodiment, by simply using the ratio of Y₁ to Y₂ which has been experimentally obtained in the field of automobiles and by multiplying the CO₂ discharge mass Y₁ at the material preparation stage by a specified factor a as expressed by the following equation.

Y₂=a×Y₁ (2)

A CO₂ discharge mass Y₃ at the delivery and use stage is given by a sum of a CO₂ discharge mass Y₃₁ of fuel consumed at the delivery and use stage and a CO₂ discharge mass Y₃₂ of a hydraulic oil and lubricant consumed at the delivery and use stage as described by the following equation.

Y₃=Y₃₁+Y₃₂ (3)

Herein, Y₃₁, and Y₃₂ are given by the following equations (4) to (8).

Y₃₁=(C₁+D₁)×(V₁+V₂+V₃) (4)

Y₃₂=(C₂+D₂)×(T×V₄)/T₀ (5)

V₁=(500×2×W)/(2.5×20) (6)

V₂=E₁×T (7)

V₃=(2.5×2×W)/(2.5×20) (8)

The symbols in these equations designate as follows.

Cj: a CO₂ discharging factor (kg/L) during production of materials

Dj: a CO₂ discharging factor (kg/L) during consumption of materials

V₁: the volume of fuel consumed (L) during a delivery from a factory to a job site

V₂: the volume of fuel consumed (L) when a vehicle (product) is in use

V₃: the volume of fuel consumed (L) during a delivery from one job site to another job site

W: machine mass (L)

E₁: fuel consumption (L/h) when a vehicle is operated in a typical operation mode

V₄: filling volume (L)

T: the effective service life (h) of a vehicle

T₀: replacement time (h)

For calculating V₁ and V₃, the distance between a factory and a job site is set to 500 km, the fuel consumption when the pay load is 20t is set to 2.5 L/km and the traveling distance from one job site to another job site is set to 25 km. The fuel consumption of the trailer is proportional to loading mass.

A CO₂ discharge mass Y₄ at the disposal and disassembling stage is given by a sum of a CO₂ discharged mass Y₄₁ of fuel consumed at the disposal stage and a CO₂ discharged mass Y₄₂ of acetylene gas and oxygen gas consumed at the disassembling stage, as described by the following equation.

Y₄=Y₄₁+Y₄₂ (9)

Herein, Y₄₁, and Y₄₂ are obtained from the following equations (10) to (14).

Y₄₁=(C₁+D₁)×V₅ (10)

Y₄₂=(C₃+D₃)×V₆+(C₄+D₄)×V₇ (11)

V₅=(150×2×W)/(2.5×20) (12)

V₆=0.65×t×L (13)

V₇=10×V₆ (14)

In the above equations,

V₅: the volume (L) of fuel consumed during a delivery from a job site to a disassembling site

V₆: the volume (L) of acetylene gas consumed during disassembling

V₇: the volume (L) of oxygen gas consumed during disassembling

t: thickness (mm)

L: fusing length (m)

For calculating the value of V₅, the distance from the job site to the disassembling site is set to 150 km.

Accordingly, the total Y of the CO₂ discharge masses is obtained from the following equation.

Y=Y₁+Y₂+Y₃+Y₄ (15)

In addition, the discharged amount of CO₂ per hour, the discharged amount of CO₂ per working amount and the contribution rate of the CO₂ discharging amount in each stage are calculated if necessary. The factors etc. used in the various arithmetic operations are classified by the models of construction machines and stored in the CO₂ discharged amount calculation table 16.

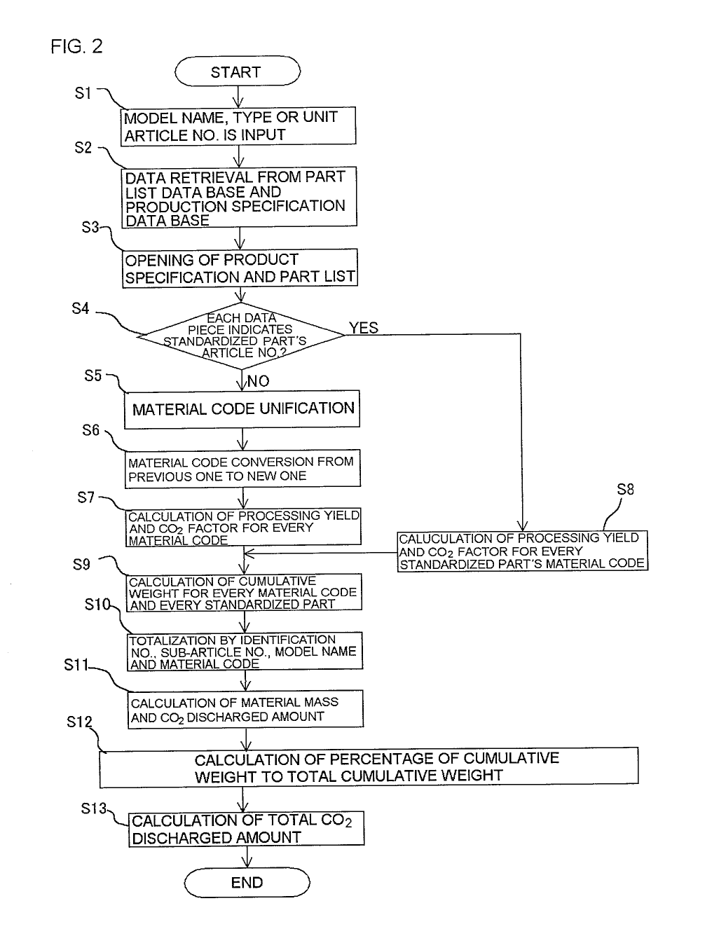

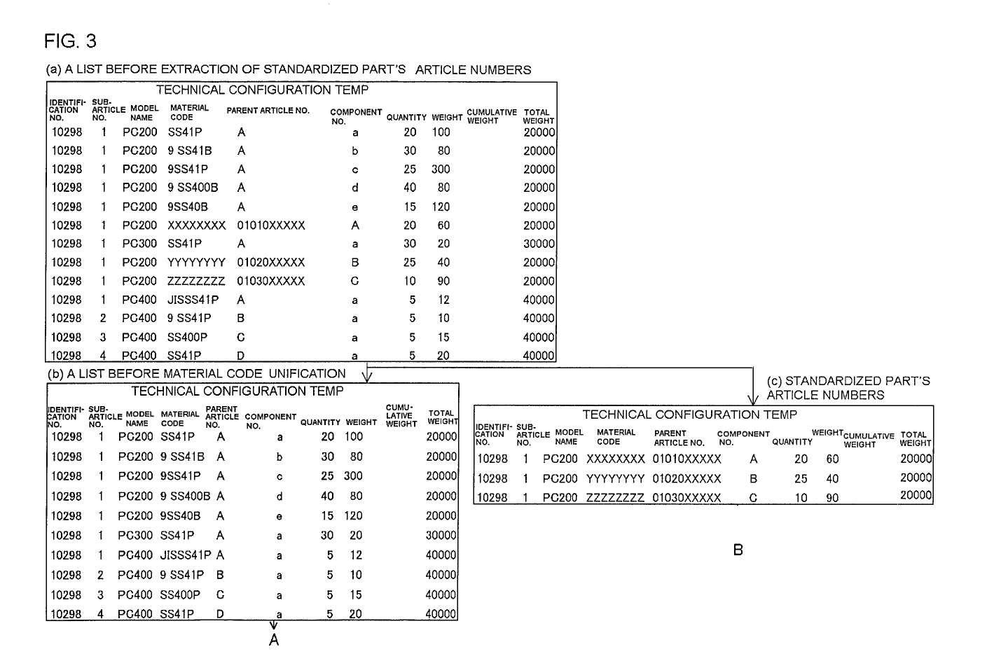

With reference to the flow chart of FIG. 2, a flow for calculating the amount of CO₂ discharged to the environment will be described in order. It should be noted that the flows of FIGS. 3 to 7 respectively show the data stored in a template (technical configuration TEMP) within the memory 7 of the CPU 1 together with examples of the table data.

Step S1: The model name and type name or unit article number of a construction machine which is an object to be evaluated are input. In this case, the above model name to be input may be the model name of a newly developed product, to say nothing of the model name of a currently marketed product. Where a newly developed model name or the like is input, the CO₂ discharged amount of this model is obtained from a simulation at the development stage. For inputting a newly developed model name, CAD/CAM data are needed to be taken in the part list data base 11 and in the product specification data base 12 beforehand.

Steps S2 to S3: Based on the input data, the par list data base 11 and the product specification data base 12 are accessed to retrieve the product specification and part list of the construction machine. The contents of the product specification and part list are stored in the template (technical configuration TEMP) within the memory 7 of the CPU 1. One example of the data stored in the template is shown in

FIG. 3(a). In this example, data on identification number, sub-article number, model name, material code, parent article number, component number, quantity, weight, cumulative weight and total weight are recorded in each column.

Step S4: For extracting standardized part's in-house article numbers from the data stored in the template, a check is made to determine whether each data piece is a standardized part's article number. If a data piece is not a standardized part's article number, the program proceeds to Step S5, and if it is a standardized part's article number, the program proceeds to Step S8. In this way, only standardized part's article number data can be extracted to be stored in the template. A condition in which only standardized part's article number data are stored in the template is shown in FIG. 3(c), while a condition in which other data than standardized part's article number data are stored in the template is shown in FIG. 3(b). In this example, parts having parent article numbers which include “0” at the top of numerals are extracted as standardized part's article numbers.

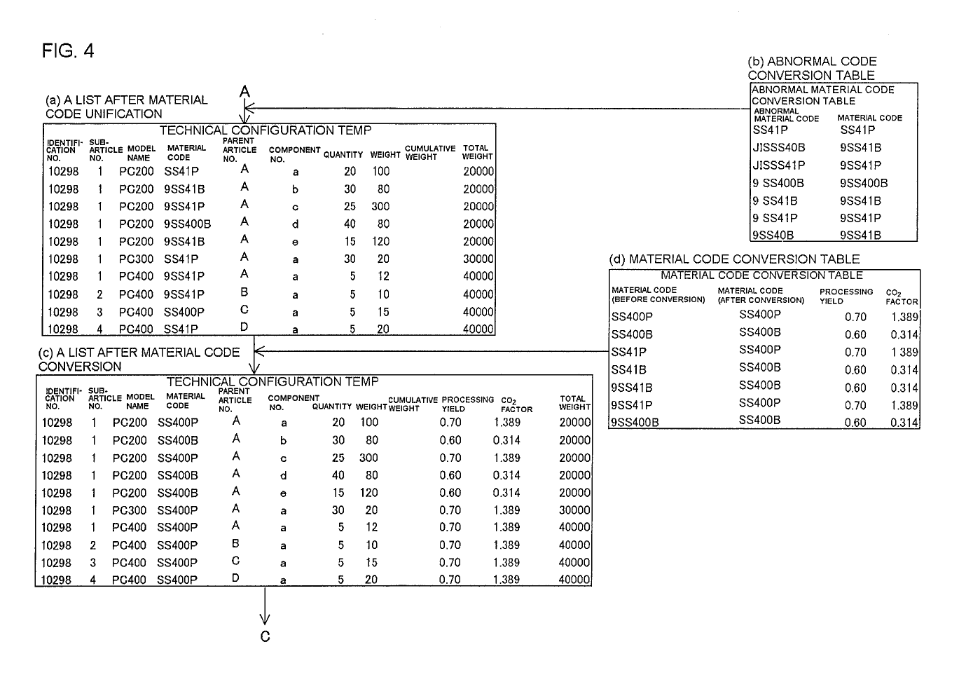

Step S5: For other data than standardized part's article number data (i.e., data on products having a general part's article number), material code unification by use of the abnormal code conversion table 13 as shown in FIG. 4(b) is performed. The reason for this is that non-standardized parts (i.e., general parts) often have non-uniform codes like JIS standardized parts which have an article number having “JIS” at the top (e.g., “JISSS40B”), an article number having, at the top, “9” which indicates a JIS standardized article (e.g., “9SS40B”), or an article number having a blank between a numeral and a material code (In the case of “9 SS41P” for instance, there is a blank between the numeral “9” and the material code “SS41P”). An example of data stored in the template after the material code unification is shown in FIG. 4(a).

Steps S6 to S7: Since the material code has been changed, conversion from a previous material code into a new material code is performed, using the material code conversion table 14 shown in FIG. 4(d). FIG. 4(c) shows one example of data stored in the template after the material code conversion. In the material code conversion table 14, a processing yield and CO₂ factor for every material code are registered and therefore, the data after the material code conversion include data on the processing yields and CO₂ factors so that a processing yield and CO₂ factor are calculated for every material code by this conversion.

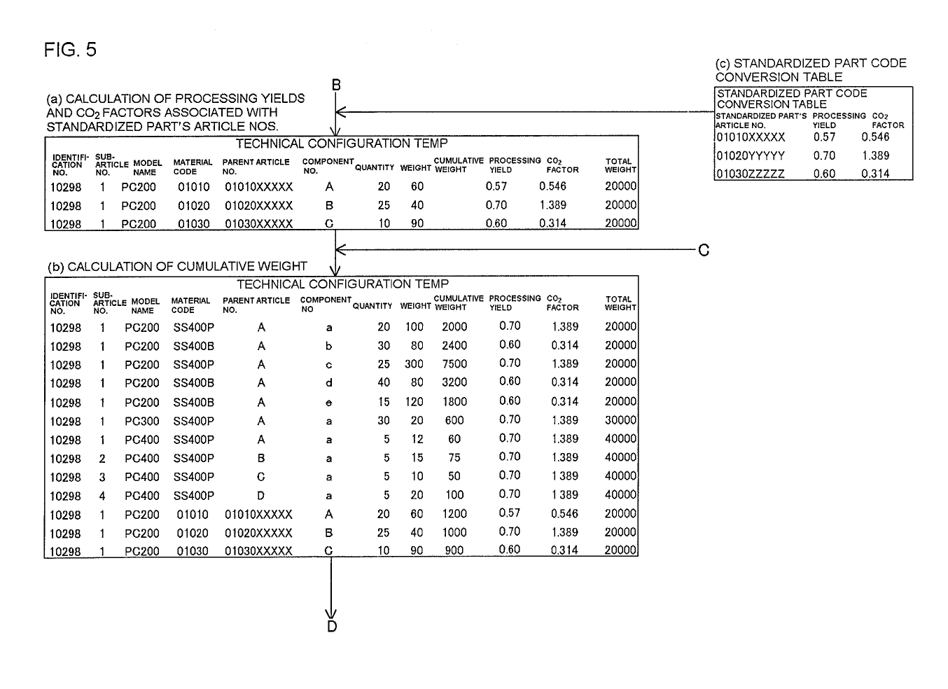

Step S8: For the standardized part's article number data extracted in Step S4, a processing yield and CO₂ factor are calculated for each material code, using the table for conversion by standardized parts 15 shown in FIG. 5(c). The material codes associated with the standardized part's article number data are respectively equal to the first five figures of their associated standardized part's article numbers. As a result of this calculation, the data shown in FIG. 5(a) are obtained.

Step S9: The standardized part's article number data and the general part's article number data are combined, and a cumulative weight for each material code is calculated using the equation [cumulative weight =quantity×weight] as shown in FIG. 5(b).

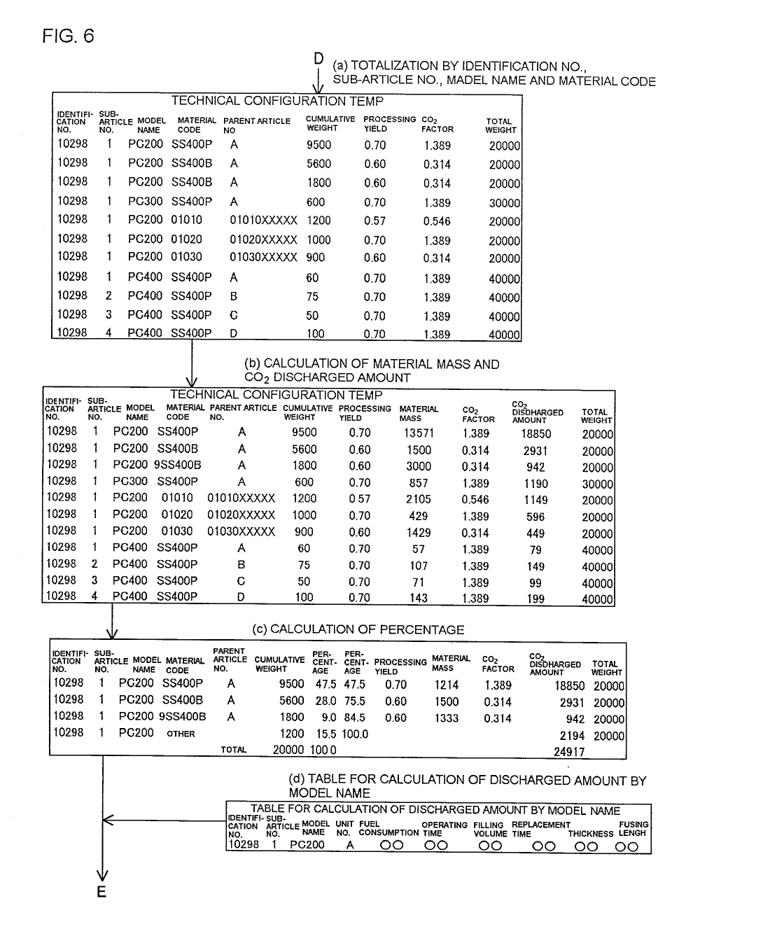

Step S10: As shown in FIG. 6(a), totalizations categorized by identification numbers, sub-article numbers, model names and material codes are performed, based on the data obtained in Step S9. In this example, among the data shown in FIG. 5(b), the data in the first column is the same as the data in the third column and the data in the second column is the same as the data in the fourth column in terms of identification number, sub-article number, model name and material code, so that the same data are combined into one data piece.

Step S11: Based on the data pieces thus obtained, the material mass is calculated using the equation [material mass=cumulative weight÷processing yield] and the CO₂ discharged amount is calculated using the equation [CO₂ discharged amount=material mass ×Co₂ factor], as shown in FIG. 6(b).

Step S12: As shown in FIG. 6(c), the total of cumulative weights is calculated and the percentage of each cumulative weight with respect to the total cumulative weight is calculated by the equation [percentage=cumulative weight÷total cumulative weight×100].

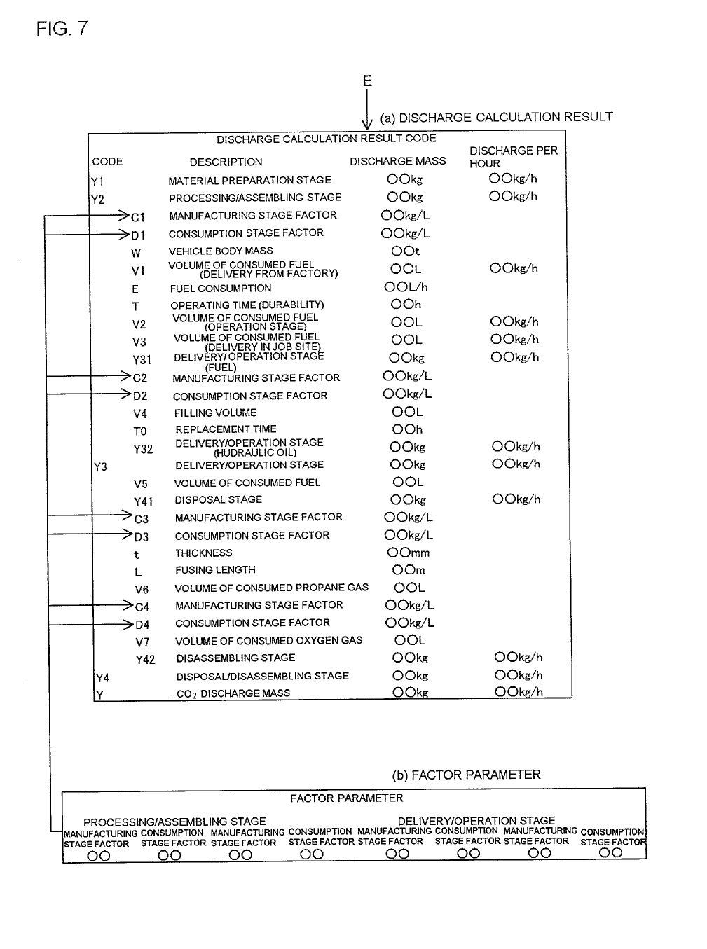

Step S13: By use of a table for calculating discharged amounts by models such as shown in FIG. 6(d) and a factor parameter table such as shown in FIG. 7(b), the values of the above equations (1) to (15) are calculated so that the calculation result shown in FIG. 7(a) is obtained.

According to the present embodiment, the amount of CO₂ discharged into the environment at each of the stages of (1) material preparation, (2) processing and assembling, (3) delivery and use and (4) disassembling and disposal can be automatically calculated by simply inputting the model name, type name or the like of a product. Thus, the invention provides a very effective system. As a matter of course, the technical concept of the invention is not limited to applications to construction machines but also applicable to all kinds of products.

While the foregoing embodiment has been described with the concept of the discharged amount of CO₂, the range of the invention covers calculation of the weight of waste such as SOx and NOx. It also covers the discharged amount and recyclability (the percentage of the weight of reusable parts at the time of disposal with respect to overall weight) of toxic substances such as PCB, asbestos, and special flon, these discharged amount and recyclability being associated with environmental indicators.

1. An environmental indicator calculation method comprising the steps of:
(1) storing a data base and a data table in a memory, the data base having a collection of data on the part lists and specifications of products in conjunction with product identification codes, the data table containing processing yields and environmental indicator factors in conjunction with material codes which respectively indicate the material of each part constituting a product;
(2) extracting part numbers by looking them up in the data base with a product identification code which has been input;
(3) calculating a processing yield and environmental indicator factor for every material code by referring the data table, the material codes relating to the parts corresponding to the part numbers which have been extracted; and
(4) calculating the discharged amount of efflux associated with an environmental indicator for every material code based on its corresponding processing yield and environmental indicator factor which have been obtained, while calculating the total amount of efflux discharged from the whole product.

2. An environmental indicator calculation apparatus comprising:
(1) a data base having a collection of data on the part lists and specifications of products in conjunction with product identification codes;
(2) a data table containing processing yields and environmental indicator factors in conjunction with material codes which respectively indicate the material of each part constituting a product; and
(3) computing means for (i) extracting part numbers and the weight of a part associated with every part number by looking them up in the data base with a product identification code which has been input, (ii) calculating a processing yield and environmental indicator factor for every material code by referring the data table, the material codes relating to the parts corresponding to the part numbers which have been extracted, and (iii) calculating the discharged amount of efflux associated with an environmental indicator for every material code based on its corresponding processing yield and environmental indicator factor which have been obtained, while calculating the total amount of efflux discharged from the whole product.

3. An environmental indicator calculation apparatus according to claim 2, wherein the discharged amount calculated by the computing means includes the discharged amount of efflux during preparation of the materials of the parts; the discharged amount of efflux during processing and assembling of the parts; the discharged amount of efflux during delivery and use of the product; and the discharged amount of efflux during disassembling and disposal of the product.

4. An environmental indicator calculation apparatus according to claim 2 or 3, further including an abnormal code conversion table for converting a material code incorrectly given into a normal material code, and after conversion of an abnormal material code into a normal material code by referring this abnormal code conversion table, said calculation of the processing yield and the environmental indicator factor is executed.

5. A computer-readable, recording medium for storing a program for executing an environmental indicator calculation process by a computer, the process comprising the steps of:
(1) extracting part numbers by looking them up in a data base with a product identification code which has been input, the data base having a collection of data on the part lists and specifications of products in conjunction with product identification codes;
(2) calculating a processing yield and environmental indicator factor for every material code by referring a data table, the material codes relating to the parts corresponding to the part numbers which have been extracted, the data table containing processing yields and environmental indicator factors in conjunction with material codes which respectively indicate the material of each part constituting a product; and
(3) calculating the discharged amount of efflux associated with an environmental indicator for every material code based on its corresponding processing yield and environmental indicator factor which have been obtained, while calculating the total amount of efflux discharged from the whole product.
